(19) United States
(12) Patent Application Publication
(10) Pub. No.: US 2011/0039228 A1
(43) Pub. Date: Feb. 17, 2011

(54) UNIVERSAL ARTICULATOR FOR THE PREPARATION OF DENTAL PROSTHESIS THROUGH TRANSFERENCE OF DOUBLE IMPRESSIONS OF THE ANTERIOR AND POSTERIOR AREAS OF THE MOUTH CAVITY

(76) Inventor: Mario Armando PELLI, Buenos Aires (AR)

Correspondence Address: DEFILLO & ASSOCIATES, INC., P.O. Box 14104, Clearwater, FL, 33766, US

(21) Appl. No.: 12/648,331

(22) Filed: Dec. 29, 2009

(30) Foreign Application Priority Data
Aug. 13, 2009 (AR) P20090103133

(51) Int. Cl. A61C 11/02

(52) U.S. Cl. 433/57

(57) ABSTRACT

Universal articulator for the preparation of dental prosthesis through transference of double impressions of the anterior and posterior areas of the mouth cavity capable of reproducing and keeping in an exact way the transference of the mouth occlusion of a patient for making up a prosthesis, the articulator is comprised by a posterior frame from which there is a projection of an upper branch connected in an articulated way from its posterior end to the upper end of the articulation frame, and a lower horizontal branch fixed in the lower part of that articulation frame. The articulator includes a fixing pin for the upper branch position with respect to the lower branch and arranged in the nearby area of the articulation frame. The front sides of the upper and lower branches and the sides of the upper branch have a series of holes for the fixing of the trays holding rods with the previously obtained impressions molds for making up the lower and upper dental members prosthesis of the anterior and posterior areas of the mouth cavity.

### FIELD OF THE INVENTION

This utility model refers to an universal articulator for the preparation of dental prosthesis through transference of double impressions of the anterior and posterior areas of the mouth cavity and more particularly to an universal articulator capable of reproducing and keeping in an exact way the transference of the mouth occlusion of a patient for making up a prosthesis, easing the position of models both corresponding to the anterior area as well as the posterior area of the mouth, without the need to resort to the use of another articulator and always keeping the essential accuracy of the adjustments required to obtain the required high quality final dental prosthesis.

### STATUS OF THE TECHNIQUE

As any skilled in the art individual may understand, the universal articulators are mechanical instruments allowing to simulate several mandibular positions and movements to copy the relationship among the maxillary and mandibular dental pieces of every particular patient with the highest possible accuracy. For this purpose, the articulators should mechanically copy the courses of the movements determined by the temporomandibular articulations, that is to say the opening and closure and excentric movements of protrusion and laterality. Most articulators are capable of copying only different mandibular positions regarding the jawbone and the cranial base, and with certain accuracy, the courses of the movements made between those positions. That is to say that the most important function of articulators is to link the position of the lower mold as suitably centered regarding the upper mold. Another important function of articulators is to copy the course of the lower teeth with respect to the upper teeth during the mandibular movements. This function is achieved with more or less accuracy depending on the type of articulator used.

Within the prior art in this field, several types of articulators can be cited, which although keeping determined structural and functional common details, they show constructive aspects which have evolved as long as certain limitations and/or inconveniences were observed which deserved to be solved with the purpose to improve their accuracy and reliability. However and despite their evolution, the articulators developed up to now, regardless the improvements obtained, one of their main drawbacks is the mechanical complexity of their structure and, therefore, the diversity of manouvers that the odontologists and denturists must carry out during their use.

Among the documents spreading the prior art, the following can be cited, for example, U.S. Pat. No. 4,900,254 of José M. Gama, claiming the priority of the Brazilian application for the MU 6601914 Utility Model granted on Feb. 13, 1990. This patent protects an universal articulator for dental prosthesis which includes an upper frame and a lower frame with their respective branches, where the posterior end of the upper frame has notched slanting wings and the front end of the lower frame has a slanting incisal table from which an incisal pin extends toward the upper frame, while from the lower frame articulating pins extend into the upper frame notches. The articulating pins are pairs of a different length, the incisal pins are of a different length and replaceable to reach an adjustable spacing among the horizontal branches of the upper and lower frames, which are kept in a parallel and horizontal position. A dental plaster support plate is removable from one or every branch by means of an easily removed coupling element. Dental plaster support retaining pins can be optionally extended through the frames.

It can be summed up that although the articulator described in U.S. Pat. No. 4,900,254 seems to comply with the technical requirements for the proper preparation of dental prosthesis, it is immediately assumed that the articulation shape between the posterior frame and the upper horizontal branch, as well as the incisal pin support in the incisal table implies careful and very accurate adjustment maneuvers. Therefore, the odontologist or denturist should have the necessary experience and skill for the use of this articulator, so as not to risk a deficient work performance. Besides, the complex structure of this articulator and the necessary accessories for its use imply a high manufacturing cost reflected in its retailing sale price.

On the other hand, it is worthwhile mentioning the AR055507P4 Utility Model titled “Universal articulator for the preparation of dental prosthesis”, belonging to the same holder of the articulator of this utility model, comprises a frame from which an upper branch is projected which is coupled on an articulated way from its posterior end to that frame, and a fixed lower horizontal branch. The upper branch has holes for the passing through of a molding plate carrying rod, the corresponding pattern plate assembly platens are adjustable to such lower and upper branches. An incisal pin passes through the front end of the upper branch for adjusting its position with respect to the lower branch. The frame upper end has side projections among which a central cavity is defined where the upper branch posterior end fits in an articulating way. Each side projection of the frame has respective holes for the passing of the corresponding articulating bolts of the upper branch. The anterior end or incisal table of the lower branch is a flat surface for supporting the incisal pin lower end. The molding plate includes a bushing for its passing and adjustment to the proximal end of its carrying rod.

Unlike the information provided by the above cited documents, the newly proposed articulator allows to partially transfer the mouth anterior area occlusion through a tray specially arranged for this purpose and having the capability to obtain with the same articulator the partial occlusion on a separate basis of the anterior and posterior area, both of a same patients as well as several patients at the same time.

Among the advantages of the universal articulator which is the subject matter of this utility model, it is worthwhile mentioning for example that it allows to reduce the work times of the odontologist for the preparation of the prosthesis models to be made, a considerable saving on impression materials such as alginates and silicones, and material for making up the models, that is to say, plaster, hard plaster and epoxy resins, without losing the accuracy and details required by the occlusion. Besides, this articulator is capable of being used with one or several cases both corresponding to the anterior or posterior area, taking into consideration the precision provided by the fixing elements (pins) which are inserted in it.

### BRIEF DESCRIPTION OF THE INVENTION

Therefore, an object of this utility model is to provide an universal articulator for the preparation of dental prosthesis through transference of double impressions of the anterior and posterior areas of the mouth, which allows to copy and maintain in an accurate way the transference of the mouth occlusion of a patient for making up a prosthesis, the articulator is comprised by a posterior frame from which there is a projection of an upper branch, coupled in an articulated way from its posterior end to the upper end of the articulation frame, and a lower horizontal branch fixed in the lower part of that articulation frame. The articulator includes a fixing pin for the upper branch position with respect to the lower branch and arranged in the nearby area of the articulation frame. The front sides of the upper and lower branches and the sides of the upper branch have a series of holes for the wedging and fastening of tray holders with the molds of the impressions previously obtained for the making up of the prosthesis corresponding to the lower and upper dental members of the anterior and posterior areas of the mouth cavity.

### BRIEF DESCRIPTION OF THE FIGURES

For a better explanation and understanding of the purpose of this utility model, it has been illustrated in several figures, in which the utility model has been represented in one preferred embodiment, all of the above in an exemplary way, where:

FIG. 1 is a perspective view of the universal articulator, where it is shown with a tray for making up the mouth upper and lower area prosthesis, covering the area corresponding to the dental members from canine to canine.

FIG. 2 is a perspective view of the universal articulator where it is shown with a posterior area tray, covering the areas corresponding to the posterior—both upper and lower—dental members of the mouth cavity.

FIG. 3 is a view of the articulator mainly taken from one of its sides, where its upper branch is shown as angled upward shifted with respect to its articulation axis.

### DETAILED DESCRIPTION OF THE INVENTION

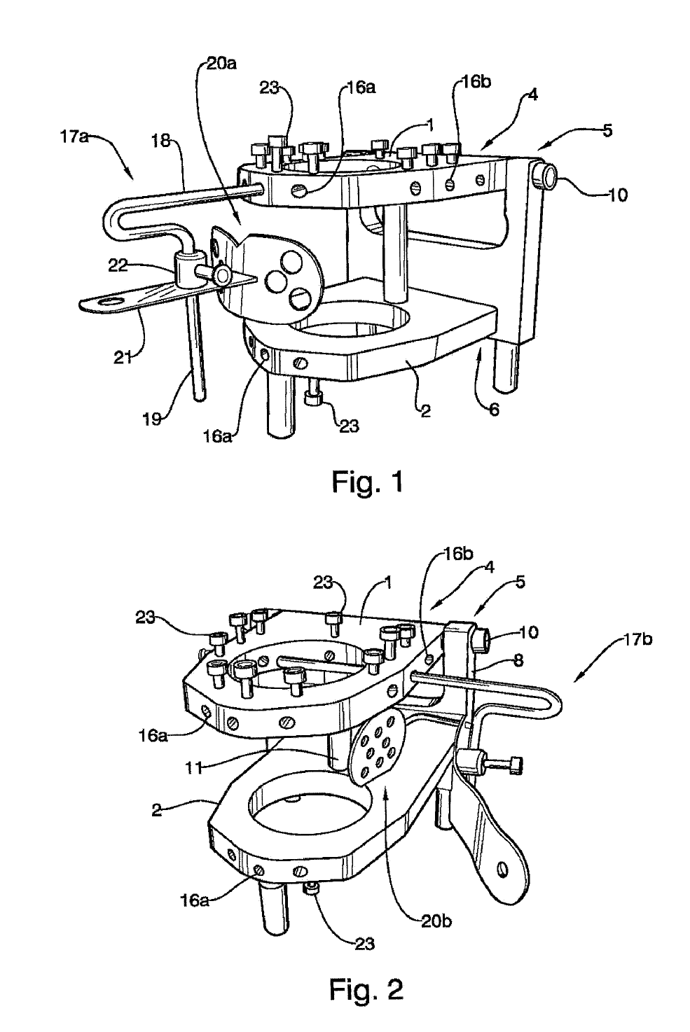

FIG. 1 shows that the articulator of this utility model is defined by a structure comprising an upper branch 1, a lower branch 2 and a posterior frame or articulation frame 3, from which such upper 1 and lower 2 branches project. The upper branch 1 is articularly connected from its posterior end 4 to the superior end 5 of the posterior frame 5. On the other hand, the lower branch 2 is fixed from its posterior end 6 in the lower part 7 of the posterior frame 3. For the articulating connection of the upper branch 1, the posterior frame 3 has side protrusions 8 among which a central cavity 9 is defined where the posterior end 4 of such upper branch 1 wedges, which is connected through screws or bolts 10.

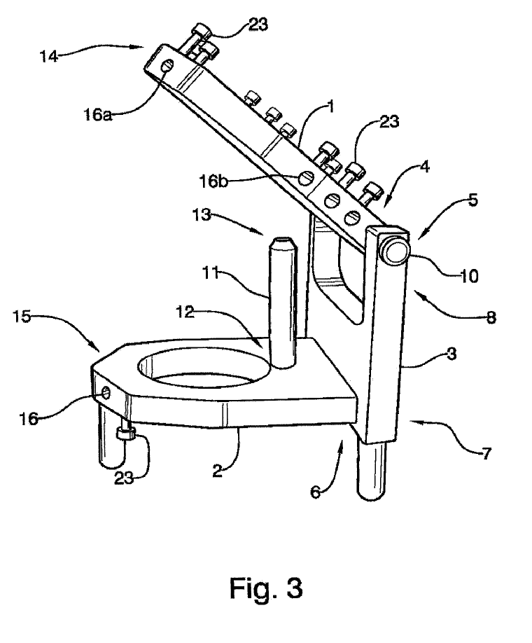

In order to fix the position of the upper branch 1 with respect to the lower branch 2, near the posterior frame 3 there is a pin 11 which extends between the inner faces of these branches 1 and 2. According to the preferred embodiments described, FIG. 3 shows that the Pin 11 is connected from its lower end 12 to the lower branch 2. In the articulators position of use, the upper branch 1 is supported on the upper end 13 of pin 11.

The front ends 14 and 15 of the upper 1 and lower 3 branches have their respective series of holes 16a for the wedging of and fixing the carrying rod 17a of the molding tray 20a destined to the molds of the mouth cavity anterior area prosthesis, which can be fixed in different angled positions with respect to the articulator longitudinal geometric axis. In each working position defined by the holes 16a, a screw 23 is available to adjust the location of the rod 17a with the tray 20a.

As shown, the rod 17a is coupled in the end 14 of the branch 1 from its upper section 18, which in its lower section 19, the tray 20a is coupled, remaining opposite the space comprised between the ends 14 and 15 of these upper 1 and lower 2 branches. A metal plate 21 with a bushing 22 and fixing screw extends from the posterior area of the molding tray 20a, through which the section 19 of the rod 17a goes through, and through which it is fixed in place in the proper position, according to every model to be prepared.

FIG. 2 shows that the upper branch 1 has a series of holes 16b to connect a rod 17b, similar to the previous one, for holding a molding tray 20b destined to the molds for the mouth cavity posterior area, which in this figure is shown located in connection with the right posterior area. Tray 20b can be connected in the different working positions defined by these holes 16b, and also there are screws 23 to adjust the rod 17a with tray 20b, as appropriate.

The following steps should be observed for the use of the articulator and making up of the models in the articulator:

a) take a double impression in the mouth of the patient, using the designed tray (20a) for the upper and lower area of the mouth, ranging from canine to canine or member 23 to member 13 and from member 33 to member 44, all at the same time and in one only step.

In the case of a posterior area, the posterior area tray 20b shall be used, that is to say from upper area 13 or 23 backwards in the mouth cavity, covering also in one only step the right lower area of the member 43 backwards or member 33 backwards in the case of a left lower area.

The selected impression material is placed in the tray retentions, according to the area to take the impression, it is placed in the patient mouth and the patient is asked to occlude in the usual position.

(b) once the impressions are obtained, the tray shall be placed on the articulator by means of the carrying rod and the screws to obtain the desired position and once adjusted, the impressions should be poured. Plaster or hard plaster can be poured starting from the upper or lower area, one at a time; once the pouring material is hardened, the other side filling shall be complemented.

(c) During the time up to the plaster or the hard plaster reaches its hardening, the positioning screws can be loosen and open the articulator branches, letting us one only position of work and occlusion to carry out the predetermined prosthesis; models are taken away, cut for their better view and they are placed again by means of the fastening pins in the work occlusion.

1. (canceled)

2. An universal articulator for the preparation of dental prosthesis through transference of double impressions comprising:
a side frame having a top end and a bottom end;
an upper frame having a front end, sides, inner face, upper face, and a back end, wherein the back end of the upper frame is hinge to the top end of the side frame;
a lower frame having a front end, sides, inner face, outer face, and a back end, wherein the back end of the lower frame is fixed to the bottom end of the side frame;
a pin extending between the inner face of the upper frame and the inner face of the lower frame;
wherein the pin is located near the back end of the upper frame and the back end of the lower frame; and
wherein the sides of the upper frame and the sides of the lower frame include plurality of orifices to receive a carrying rod connected to a molding tray.

3. The universal articulator according to claim 2, wherein the molding tray is secured to the orifices in different angled positions with respect to the universal articulator longitudinal geometric axis.

4. The universal articulator according to claim 2, wherein the outer face of the upper frame and the outer face of the lower frame further comprise a screw located on each orifice to secure the carrying rod to the upper frame or the lower frame.

5. The universal articulator according to claim 2, wherein the upper side of the side frame further comprises orifices that connect with wedges located on the outer side of the back end of the upper frame.

6. The universal articulator according to claim 2, further comprising a metal plate extending from the outer side of the molding tray, wherein the carrying rod passes through a hole on the metal plate.
